(19) United States
(12) Patent Application Publication
(10) Pub. No.: US 2020/0097862 A1
(43) Pub. Date: Mar. 26, 2020

(54) METHOD AND SYSTEM FOR OWNERSHIP VERIFICATION VIA BLOCKCHAIN

(71) Applicant: MASTERCARD INTERNATIONAL INCORPORATED, Purchase, NY (US)

(72) Inventors: Ankur Arora, New Delhi (IN); Chavan Yadav, Gurugram (IN); Shashank Kumar Trivedi, New Delhi (IN)

(73) Assignee: MASTERCARD INTERNATIONAL INCORPORATED, Purchase, NY (US)

(21) Appl. No.: 16/142,107

(22) Filed: Sep. 26, 2018

(51) Int. Cl. G06Q 10/02; H04L 9/32; H04L 9/30; G06K 7/14

(52) U.S. Cl. CPC G06Q 10/02; H04L 9/3247; H04L 2209/38; G06K 7/1413; H04L 9/30

(57) ABSTRACT

A method for validating ticket authenticity includes: reading, by an optical imaging device interfaced with a computing device, a displayed machine-readable code encoded with a ticket identification value; receiving, by a receiver of the computing device, at least a digital signature from a mobile computing device; identifying, by the computing device, a blockchain data entry included in one of a plurality of blocks comprising a blockchain, wherein the blockchain data entry includes at least the ticket identification value and a public key of a cryptographic key pair; validating, by the computing device, authenticity of a ticket based on validation of the digital signature using the public key; and outputting, by the computing device, the result of the validation of the authenticity of the ticket.

### FIELD

The present disclosure relates to the verification of ownership using a blockchain, specifically the authentication of a ticket or other item directly associated with a mobile computing device through the use of a blockchain to prevent fraud and unauthorized usage.

### BACKGROUND

Event tickets and other similar items often use machine-readable codes, such as bar codes or quick response (QR) codes for conveying data to make redemption or usage thereof faster and easier to track. For example, a ticket to an event will often have a barcode printed thereon, which is scanned to gain entry to the event. When the ticket's barcode is scanned, that ticket is registered as having been used where the system keeps track of the occurrence. However, there is often a lack of any check or further authentication used to ensure that the ticket is not fraudulent and that usage of the ticket is authorized. As a result, a nefarious actor can simply create a photocopy of the ticket and, if that photocopy is scanned for entry first, can enter into the event and prohibit the owner of the legitimate ticket from entering.

Thus there is a need for added security to ensure that a ticket or other item is only being used by an authorized entity. This presents a technical problem, particularly when brought to scale of thousands or tens of thousands of tickets being reviewed.

### SUMMARY

The present disclosure provides a description of systems and methods for validating ticket authenticity using a blockchain. When a ticket is purchased, an entry is created on a blockchain that stores data identifying the ticket as well as information unique to the ticket's purchaser, either a device identifier for their mobile device or a public key for which the mobile device has the corresponding private key. When redemption of the ticket is requested, the user must present, in addition to the ticket, their mobile device, which provides its identifier or a digital signature generated using the private key. The system then identifies the blockchain entry for the ticket and compares the device identifier or validates the digital signature with the public key, as applicable. Successful verification means that the user is genuine or at least authorized, and entry to the event or other action is performed. If the initial ticket owner wants to transfer ownership, the same process can be performed with the result being a new blockchain entry created for the new user.

A method for validating ticket authenticity includes: reading, by an optical imaging device interfaced with a computing device, a displayed machine-readable code encoded with a ticket identification value; receiving, by a receiver of the computing device, at least a receiver device identifier associated with a mobile computing device from the mobile computing device; identifying, by the computing device, a blockchain data entry included in one of a plurality of blocks comprising a blockchain, wherein the blockchain data entry includes at least the ticket identification value and a blockchain device identifier; validating, by the computing device, authenticity of a ticket based on a comparison of the receiver device identifier to the blockchain device identifier; and outputting, by the computing device, the result of the validation of the authenticity of the ticket.

Another method for validating ticket authenticity includes: reading, by an optical imaging device interfaced with a computing device, a displayed machine-readable code encoded with a ticket identification value; receiving, by a receiver of the computing device, at least a digital signature from a mobile computing device; identifying, by the computing device, a blockchain data entry included in one of a plurality of blocks comprising a blockchain, wherein the blockchain data entry includes at least the ticket identification value and a public key of a cryptographic key pair; validating, by the computing device, authenticity of a ticket based on validation of the digital signature using the public key; and outputting, by the computing device, the result of the validation of the authenticity of the ticket.

A system for validating ticket authenticity includes: an optical imaging device interfaced with a computing device configured to read a displayed machine-readable code encoded with a ticket identification value; a receiver of the computing device configured to receive at least a receiver device identifier associated with a mobile computing device from the mobile computing device; and the computing device configured to identify a blockchain data entry included in one of a plurality of blocks comprising a blockchain, wherein the blockchain data entry includes at least the ticket identification value and a blockchain device identifier, validate authenticity of a ticket based on a comparison of the receiver device identifier to the blockchain device identifier, output the result of the validation of the authenticity of the ticket.

Another system for validating ticket authenticity includes: an optical imaging device interfaced with a computing device configured to read a displayed machine-readable code encoded with a ticket identification value; a receiver of the computing device configured to receive at least a digital signature from a mobile computing device; and a computing device configured to identify a blockchain data entry included in one of a plurality of blocks comprising a blockchain, wherein the blockchain data entry includes at least the ticket identification value and a public key of a cryptographic key pair, validate authenticity of a ticket based on validation of the digital signature using the public key, and output the result of the validation of the authenticity of the ticket.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for validating ticket authenticity using blockchain in accordance with exemplary embodiments.

FIG. 2 is a block diagram illustrating the ticketing system of the system of FIG. 1 for verifying ticket ownership and authenticity using a blockchain in accordance with exemplary embodiments.

FIG. 3 is a flow diagram illustrating a process for verification of authenticity of a ticket and redemption thereof in the system of FIG. 1 in accordance with exemplary embodiments.

FIGS. 4 and 5 are flow charts illustrating exemplary methods for validating ticket authenticity in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Blockchain—A public ledger of all transactions of a blockchain-based currency. One or more computing devices may comprise a blockchain network, which may be configured to process and record transactions as part of a block in the blockchain. Once a block is completed, the block is added to the blockchain and the transaction record thereby updated. In many instances, the blockchain may be a ledger of transactions in chronological order, or may be presented in any other order that may be suitable for use by the blockchain network. In some configurations, transactions recorded in the blockchain may include a destination address and a currency amount, such that the blockchain records how much currency is attributable to a specific address. In some instances, the transactions are financial and others not financial, or might include additional or different information, such as a source address, timestamp, etc. In some embodiments, a blockchain may also or alternatively include nearly any type of data as a form of transaction that is or needs to be placed in a distributed database that maintains a continuously growing list of data records hardened against tampering and revision, even by its operators, and may be confirmed and validated by the blockchain network through proof of work and/or any other suitable verification techniques associated therewith. In some cases, data regarding a given transaction may further include additional data that is not directly part of the transaction appended to transaction data. In some instances, the inclusion of such data in a blockchain may constitute a transaction. In such instances, a blockchain may not be directly associated with a specific digital, virtual, fiat, or other type of currency.

### System for Validating Ticket Authenticity Using Blockchain

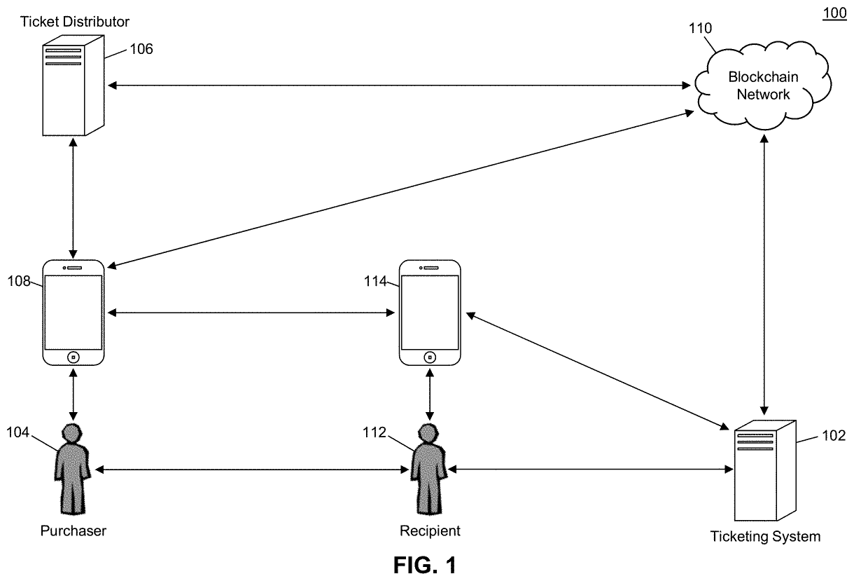

FIG. 1 illustrates a system 100 for the validation of ticket authenticity and ownership for entry to event or other similar redemption via the use of a blockchain.

The system 100 may include a ticketing system 102. The ticketing system 102, discussed in more detail below, may be configured to validate the authenticity of tickets and confirm ownership thereof through the use of a blockchain. In the system 100, a purchaser 104 may purchase a ticket, which may be used to gain entry into an event, may be redeemed for a good or service, or otherwise used in return for some form of benefit. The purchaser 104 may purchase the ticket from a ticket distributor 106. In some embodiments the ticket distributor 106 may be an entity separate from the ticketing system 102 operating in association therewith. In other embodiments, the ticket distributor 106 may be a part of the ticketing system 102 or vice versa. In some cases, the ticket distributor 106 may be a third party entity, such as a ticket reseller, configured to distribute tickets to purchasers 104 and track the purchase and transfer thereof.

The purchaser 104 may purchase a ticket from the ticket distributor 106. The ticket may have a unique identifier associated therewith, referred to herein as a ticket identification value. The ticket identification value may be a value unique to that specific ticket, and may be represented using any suitable type of value, such as an integer, alphanumeric value, etc., which may be any number of digits suitable for providing uniqueness to the value. As part of the purchase of the ticket, the purchaser 104 may provide data associated with a purchaser device 108 to the ticket distributor 106. The purchaser device 108 may be a computing device that the purchaser 104 may be required to either present or prove ownership of as part of the redemption or other usage of the purchased ticket. The purchaser device 108 may be, for instance, a cellular phone, smart phone, smart watch, wearable computing device, implantable computing device, tablet computer, etc.

The data associated with the purchaser device 108 may be data that is unique to the purchaser device 108 that can be presented to the ticketing system 102 as part of the usage of the purchased ticket to prove that the purchaser 104 is the authorized purchaser of the ticket. In one embodiment, the purchaser 104 may provide a device identifier that is unique to the purchaser device to the ticket distributor 106, such as a media access control address, internet protocol address, registration number, serial number, telephone number, etc. In some cases, the purchaser 104 may use the purchaser device 108 to purchase the ticket, where the purchaser device 108 may provide the device identifier to the ticket distributor 106 as part of the purchasing process. In another embodiment, the purchaser device 108 may have a cryptographic key pair associated therewith comprised of a private key and public key. In such an embodiment, the purchaser device 108 may provide the public key to the ticket distributor 106 as the unique data.

Once the purchaser 104 has purchased the ticket, the ticket distributor 106 may register the ticket purchase with a blockchain network 110. The blockchain network 110 may be comprised of a plurality of nodes, where each node is a computing system configured to maintain a copy of the blockchain associated with the blockchain network 110, generate new blocks for addition to the blockchain, verify proposed blocks, and perform other functions related to the maintenance of the blockchain. The blockchain itself may be a distributed ledger that is comprised of at least a plurality of blocks. Each block may include at least a block header and one or more data values. Each block header may include at least a timestamp, a block reference value, and a data reference value. The timestamp may be a time at which the block header was generated, and may be represented using any suitable method (e.g., UNIX timestamp, DateTime, etc.). The block reference value may be a value that references an earlier block (e.g., based on timestamp) in the blockchain. In some embodiments, a block reference value in a block header may be a reference to the block header of the most recently added block prior to the respective block. In an exemplary embodiment, the block reference value may be a hash value generated via the hashing of the block header of the most recently added block. The data reference value may similarly be a reference to the one or more data values stored in the block that includes the block header. In an exemplary embodiment, the data reference value may be a hash value generated via the hashing of the one or more data values. For instance, the block reference value may be the root of a Merkle tree generated using the one or more data values.

The use of the block reference value and data reference value in each block header may result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single node in the blockchain network 110 prior to the generation and addition of a new block to the blockchain in order for the change to be made permanent. Computational and communication limitations may make such a modification exceedingly difficult, if not impossible, thus rendering the blockchain immutable.

Each data value in the blockchain, also referred to herein as blockchain data entries, may be related to a ticket and the ownership thereof. When the purchaser 104 purchases a ticket from the ticket distributor 106, the ticket distributor 106 may submit the ticket identification value for the ticket and the data provided by the purchaser 104 for the purchaser device 108 (e.g., the device identifier or public key) to a node in the blockchain network 110. The node may create a new blockchain data entry that includes the ticket identification value and purchaser device 108 data. The blockchain data entry may be included in a new block that is generated and validated by other nodes in the blockchain network 110 before being added into the blockchain. In some cases, a node may transmit a notification to the ticket distributor 106 indicating when the new blockchain data entry has been successfully added to the blockchain.

When the purchaser 104 wishes to use the ticket, they may present the ticket (e.g., as a physical item with a machine-readable code displayed thereon or as an electronic ticket such as may be displayed on the purchaser device 108) as well as their purchaser device 108 to the ticketing system 102. The ticketing system 102 may scan the machine-readable code for the ticket to obtain the ticket identification value encoded therein. The ticketing system 102 may also receive data from the purchaser device 108 used for the additional authentication. In the case where a device identifier is used, the purchaser device 108 may provide the device identifier to the ticketing system 102. In the case where cryptographic keys are used, the purchaser device 108 may generate a digital signature using the private key, where the digital signature may be provided to the ticketing system 102. In either instance, the purchaser device 108 may provide the data to the ticketing system 102 using any suitable method, such as a direct electronic transmission (e.g., via a local area network, near field communication, radio frequency, Bluetooth, infrared, etc.) or via other electronic transmission such as display in a machine-readable code read by the ticketing system 102.

Once the ticketing system 102 has received the ticket identification value and the additional data from the purchaser device 108, the ticketing system 102 may verify the authenticity of the ticket and the authorization of the purchaser 104 for usage thereof. The ticketing system 102 may contact the blockchain network 110 to identify the latest blockchain data entry related to the ticket using the ticket identification value. The ticketing system 102 may then verify authenticity of the ticket by checking the data provided by the purchaser device 108 with the other data included in the blockchain data entry. For device identifiers, the ticketing system 102 may verify that the device identifier supplied by the purchaser device 108 when the ticket is being used matches the device identifier that is in the blockchain data entry, which will ensure that the purchaser 104 that is using the ticket is the same purchaser of the ticket itself. For cryptographic keys, the ticketing system 102 may validate the digital signature supplied by the purchaser device 108 using the public key included in the blockchain data entry using a suitable signature generation algorithm.

If the verification is unsuccessful, the ticketing system 102 may determine that the ticket is not authentic and/or that the purchaser 104 is not authorized to use the ticket. If the verification is successful, then the purchaser 104 may be provided with the benefit associated with usage of the ticket, such as entry into an event, supplying of goods or services, etc. In some cases, the ticketing system 102 may be an automatic system where a locking mechanism may be unlocked upon successful verification, providing the purchaser 104 with entry into an area or container to gain the benefit of the ticket. In some embodiments, once the ticket has been used, the ticketing system 102 may electronically transmit a notification to a node in the blockchain network 110 to add a new blockchain entry for the ticket that indicates redemption of the ticket. The new blockchain data entry may include, for instance, the ticket identification value and additional data that would result in any future verification to be unsuccessful, such as a null device identifier or public key.

In some embodiments, the purchaser 104 may be allowed to transfer ownership of the ticket to a recipient 112. For instance, the purchaser 104 may give the ticket as a gift to the recipient 112 or may sell the ticket to the recipient 112 as a reseller or if the purchaser 104 is unable or unwilling to attend the event. In such embodiments, the purchaser 104 may provide the ticket to the recipient 112, such as by giving a physical ticket to the recipient 112 or transmitting an electronic ticket from the purchaser device 108 to a recipient device 114. The recipient device 114 may be a computing device similar to the purchaser device 108 configured to perform the same functions associated therewith as discussed herein. The purchaser device 108 may also be configured to submit data to a node in the blockchain network 110 to facilitate the transfer of ownership of the ticket, where the data includes the ticket identification value and data identifying the recipient device 114, such as the recipient device's device identifier or a public key thereof. In some cases, the purchaser device 108 may provide the data to the ticket distributor 106, which may contact the blockchain network 110 on behalf of the purchaser device 108. Once the blockchain network 110 has added the new blockchain data entry to the blockchain, the recipient 112 may be free to use the ticket, where it is verified using the process discussed above.

The methods and systems discussed herein provide for stronger verification of authenticity of a ticket and authorized usage thereof via the use of a blockchain. The result is a reduction in fraud that can be perpetrated on ticket redemption even when using existing tickets as traditional ticket scanning and barcodes can be used in conjunction with the methods and systems discussed herein. The use of a blockchain provides an immutable record of ticket ownership that can track all ticket purchases and transfers of ownership to help further prevent fraud and to easily audit ownership transfers to identify fraud in instances where it may still occur. Thus the ticketing system 102 provides for a drastic improvement over traditional ticket redemption systems featuring increased security and reliability.

### Ticketing System

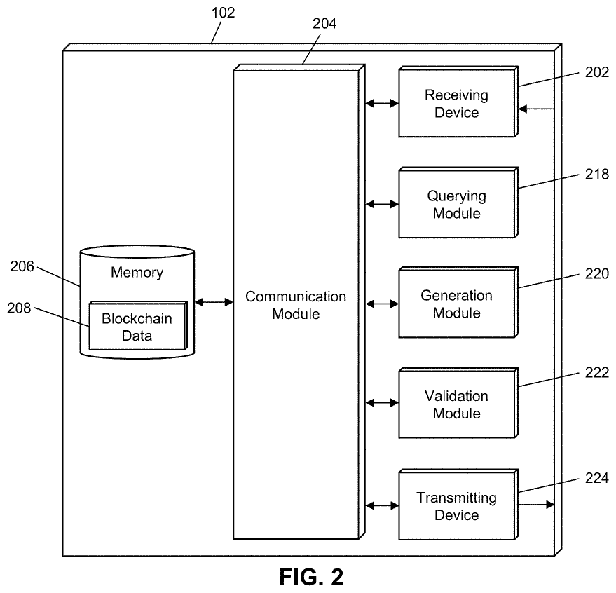

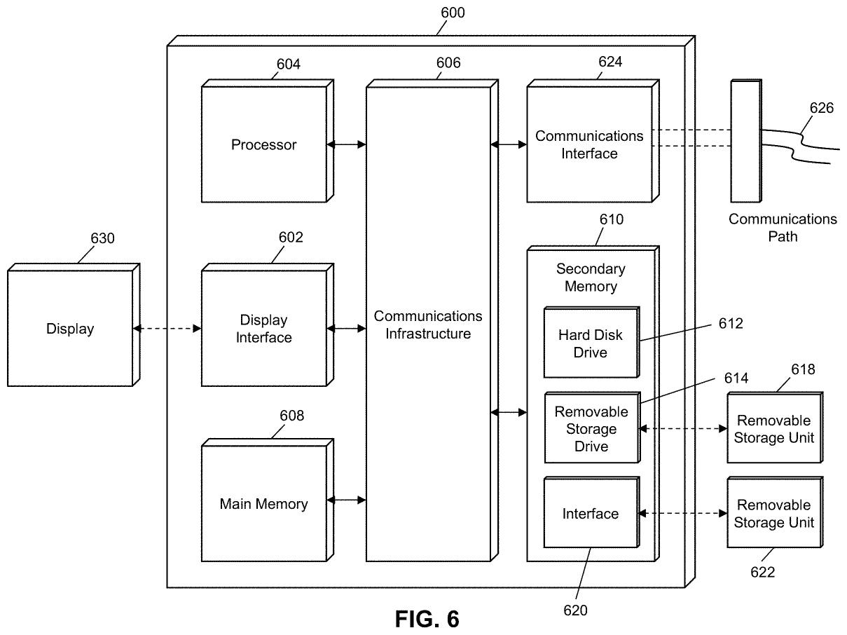

FIG. 2 illustrates an embodiment of a ticketing system 102 in the system 100. It will be apparent to persons having skill in the relevant art that the embodiment of the ticketing system 102 illustrated in FIG. 2 is provided as illustration only and may not be exhaustive to all possible configurations of the ticketing system 102 suitable for performing the functions as discussed herein. For example, the computer system 600 illustrated in FIG. 6 and discussed in more detail below may be a suitable configuration of the ticketing system 102.

The ticketing system 102 may include a receiving device 202. The receiving device 202 may be configured to receive data over one or more networks via one or more network protocols. In some instances, the receiving device 202 may be configured to receive data from purchaser devices 108, recipient devices 114, blockchain networks 110, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by purchaser devices 108 or recipient devices 114 that are superimposed or otherwise encoded with device identifiers and/or digital signatures, and may also be superimposed or otherwise encoded with ticket identification values. In some cases, ticket identification values and other data received from purchaser devices 108 or recipient devices 114 may be transmitted in separate messages or through separate methods. The receiving device 202 may also be configured to receive data signals electronically transmitted by nodes in a blockchain network 110, which may be superimposed or otherwise encoded with blocks or blockchain data entries included therein.

The ticketing system 102 may also include a communication module 204. The communication module 204 may be configured to transmit data between modules, engines, databases, memories, and other components of the ticketing system 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the ticketing system 102 and external components of the ticketing system 102, such as externally connected databases, display devices, input devices, etc. The ticketing system 102 may also include a processing device. The processing device may be configured to perform the functions of the ticketing system 102 discussed herein as will be apparent to persons having skill in the relevant art. In some embodiments, the processing device may include and/or be comprised of a plurality of engines and/or modules specially configured to perform one or more functions of the processing device, such as a querying module 218, generation module 220, validation module 222, etc. As used herein, the term “module” may be software or hardware particularly programmed to receive an input, perform one or more processes using the input, and provides an output. The input, output, and processes performed by various modules will be apparent to one skilled in the art based upon the present disclosure.

The ticketing system 102 may also include a memory 206. The memory 206 may be configured to store data for use by the ticketing system 102 in performing the functions discussed herein, such as public and private keys, symmetric keys, etc. The memory 206 may be configured to store data using suitable data formatting methods and schema and may be any suitable type of memory, such as read-only memory, random access memory, etc. The memory 206 may include, for example, encryption keys and algorithms, communication protocols and standards, data formatting standards and protocols, program code for modules and application programs of the processing device, and other data that may be suitable for use by the ticketing system 102 in the performance of the functions disclosed herein as will be apparent to persons having skill in the relevant art. In some embodiments, the memory 206 may be comprised of or may otherwise include a relational database that utilizes structured query language for the storage, identification, modifying, updating, accessing, etc. of structured data sets stored therein.

The memory 206 may be configured to store blockchain data 208. The blockchain data 208 may include a plurality of blocks that comprise a blockchain, where each block includes at least a block header and one or more blockchain data entries. Each block header may include at least a timestamp, block reference value, and data reference value. Each blockchain data entry may be related to a ticket and ownership thereof and may include at least a ticket identification value and additional data related to a computing device, such as a device identifier or public key.

The ticketing system 102 may include a querying module 218. The querying module 218 may be configured to execute queries on databases to identify information. The querying module 218 may receive one or more data values or query strings, and may execute a query string based thereon on an indicated database, such as the memory 206, to identify information stored therein. The querying module 218 may then output the identified information to an appropriate engine or module of the ticketing system 102 as necessary. The querying module 218 may, for example, execute a query on the memory 206 to identify a blockchain data entry stored in the blockchain data 208 that includes a ticket identification value read from a ticket presented to the ticketing system 102 for identification of the additional value included therein.

The ticketing system 102 may also include a generation module 220. The generation module 220 may be configured to generate data for use by the ticketing system 102 in performing the functions discussed herein. The generation module 220 may receive instructions as input, may generate data based on the instructions, and may output the generated data to one or more modules of the ticketing system 102. For example, the generation module 220 may be configured to generate notifications and other data messages for transmission to purchaser devices 108, recipient devices 114, etc. In embodiments where the ticketing system 102 may be a node in the blockchain network 110, the generation module 220 may also be configured to generate data values, block headers, and blocks for inclusion in the blockchain. The generation module 220 may also be configured to generate blockchain data entries for transmission to a node in the blockchain network 110 for inclusion in a new block.

The ticketing system 102 may also include a validation module 222. The validation module 222 may be configured to perform validations for the ticketing system 102 as part of the functions discussed herein. The validation module 222 may receive instructions as input, may validate data as instructed, and may output a result of the validation to another module or engine of the ticketing system 102. In some cases, the data to be validated may be included in the input to the validation module 222. In other cases, the validation module 222 may be configured to identify the data for validation. The validation module 222 may be configured to, for example, validate ticket authenticity and authorized usage thereof by validating digital signatures using public keys found in blockchain data entries and/or validating received device identifiers as compared to device identifiers identified in blockchain data entries.

The ticketing system 102 may also include a transmitting device 224. The transmitting device 224 may be configured to transmit data over one or more networks via one or more network protocols. In some instances, the transmitting device 224 may be configured to transmit data to purchaser devices 108, recipient devices 114, blockchain networks 110, and other entities via one or more communication methods, local area networks, wireless area networks, cellular communication, Bluetooth, radio frequency, the Internet, etc. In some embodiments, the transmitting device 224 may be comprised of multiple devices, such as different transmitting devices for transmitting data over different networks, such as a first transmitting device for transmitting data over a local area network and a second transmitting device for transmitting data via the Internet. The transmitting device 224 may electronically transmit data signals that have data superimposed that may be parsed by a receiving computing device. In some instances, the transmitting device 224 may include one or more modules for superimposing, encoding, or otherwise formatting data into data signals suitable for transmission.

The transmitting device 224 may be configured to electronically transmit data signals to purchaser devices 108 and recipient devices 114 superimposed or otherwise encoded with requests for ticket identification values, device identifiers, or digital signatures for use in performing the functions discussed herein. The transmitting device 224 may also be configured to electronically transmit data signals superimposed or otherwise encoded with notification messages to purchaser devices 108 and recipient devices 114, such as indicating successful or unsuccessful ticket verification. The transmitting device 224 may be further configured to electronically transmit data signals to nodes in the blockchain network 110 that are superimposed or otherwise encoded with requests for blockchain data entries, which may, in some instances, include a specific ticket identification value for which a blockchain data entry is requested.

### Process for Authentication and Usage of a Ticket

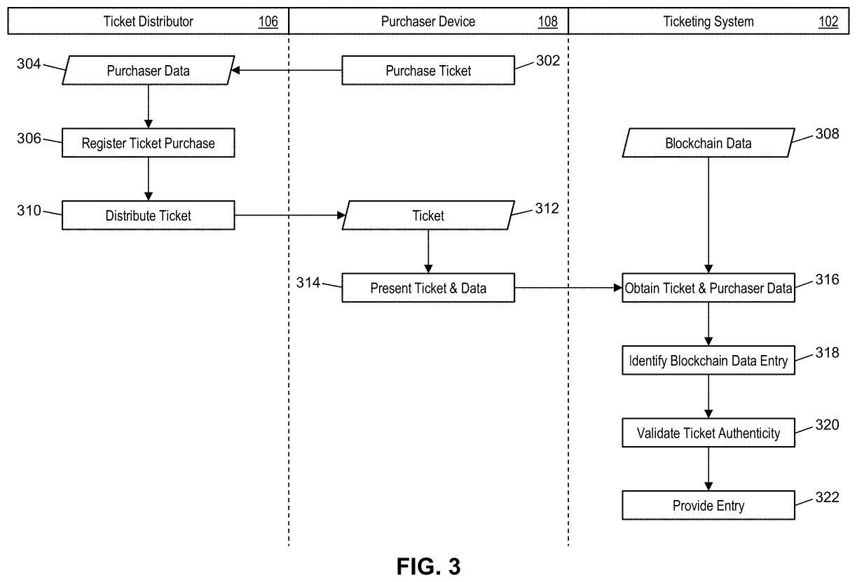

FIG. 3 illustrates an example process for the verification of the authenticity of a ticket and usage thereof in the system 100 of FIG. 1 that utilizes a blockchain for added authenticity and fraud prevention.

In step 302, the purchaser 104 may, using their purchaser device 108, purchase a ticket from a ticket distributor 106. As part of the purchase, the purchaser device 108 may electronically transmit data associated with the purchaser device 108 to the ticket distributor 106. In step 304, the ticket distributor 106 may receive the purchaser data, which may include a device identifier, public key, or other data unique to the purchaser device 108. In step 306, the ticket distributor 106 may register the purchase of the ticket with the blockchain network 110. Registration of the purchase may include submission of a ticket identification value unique to the purchased ticket as well as the purchaser data to a node in the blockchain network 110, where the node may then generate a blockchain data entry that includes the data that is included in a newly-generated block that is validated and added to the blockchain. In step 308, the receiving device 202 of the ticketing system 102 may receive updated blockchain data 208, which may be stored in the memory 206 of the ticketing system 102, and may include the blockchain data entry newly created for the ticket purchase.

In step 310, the ticket distributor 106 may distribute the purchased ticket to the purchaser device 108. In step 312, the purchaser device 108 may receive the purchased ticket, which may have a machine-readable code displayed thereon or associated therewith that is encoded with the ticket identification value unique to the ticket. In step 314, the purchaser 104 may present the ticket and purchaser data to the ticketing system 102 using the purchaser device 108. In instances where the purchaser data involves cryptographic keys, the purchaser device 108 may generate a digital signature using its private key to provide to the ticketing system 102. In some cases, the ticket and purchaser data may be presented to the ticketing system 102 at the same time, such as the ticket identification value and purchaser data either being encoded in a single machine-readable code, or electronically transmitted in a single electronic transmission. In other cases, the ticket identification value and purchaser data may be conveyed to the ticketing system 102 separately, using the same or varied communication methods. For example, the ticket may be displayed for reading of a barcode that contains the ticket identification value while the device identifier or digital signature may be electronically transmitted to the ticketing system 102, such as through near field communication.

In step 316, the receiving device 202 may receive the ticket identification value and purchaser data from the purchaser device 108 using suitable communication methods and networks. In step 318, the querying module 218 of the ticketing system 102 may execute a query on the memory 206 of the ticketing system 102 to identify a blockchain data entry in the blockchain data 208 that includes the ticket identification value. In some cases, the ticketing system 102 may identify the most recently added blockchain data entry that includes the ticket identification value (e.g., in case of transfers of ownership). In step 320, the validation module 222 of the ticketing system 102 may validate the authenticity of the ticket by comparing the purchaser data received from the purchaser device 108 in step 316 with the purchaser data included in the identified blockchain data entry. In cases where the purchaser data received from the purchaser device 108 is a digital signature, step 320 may include validating the digital signature with the public key included in the identified blockchain data entry. Upon successful verification, in step 322, the ticketing system 102 may provide entry to the purchaser 104 into the event to which the ticket pertains.

### First Exemplary Method for Validating Ticket Authenticity

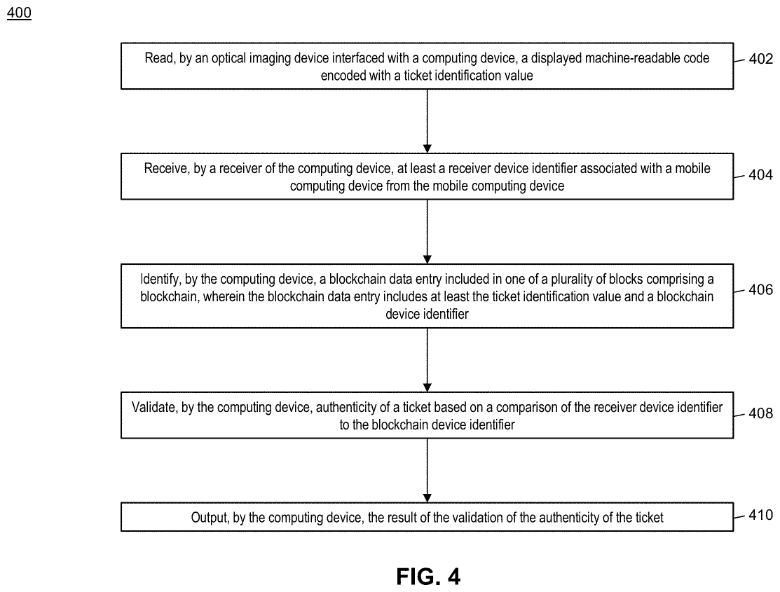

FIG. 4 illustrates a method 400 for the validation of ticket authenticity using a blockchain through the use of a device identifier associated with a computing device to which the ticket is registered.

In step 402, a displayed machine-readable code encoded with a ticket identification value is read by an optical imaging device (e.g., the receiving device 202) interfaced with a computing device (e.g., the ticketing system 102). In step 404, at least a receiver device identifier associated with a mobile computing device (e.g., the purchaser device 108) may be received by a receiver (e.g., the receiving device 202) of the computing device from the mobile computing device.

In step 406, a blockchain data entry included in one of a plurality of blocks comprising a blockchain may be identified by the computing device, wherein the blockchain data entry includes at least the ticket identification value and a blockchain device identifier. In step 408, authenticity of a ticket may be validated by the computing device based on a comparison of the receiver device identifier to the blockchain device identifier. In step 410, the result of the validation of the authenticity of the ticket may be output by the computing device.

In one embodiment, the method 400 may further include electronically transmitting, by a transmitter (e.g., the transmitting device 224) of the computing device, at least the receiver device identifier to an external system if validation of the authenticity of the ticket is unsuccessful. In some embodiments, outputting the result of the validation may include electronically transmitting, by a transmitter of the computing device, a signal to a locking mechanism interfaced with the computing device instructing the locking mechanism to unlock if the validation of the authenticity of the ticket is successful. In one embodiment, the method 400 may also include: receiving, by the receiver of the computing device, an ownership transfer request including at least the ticket identification value, an originating device identifier, and the blockchain device identifier; and electronically transmitting, by a transmitter of the computing device, at least the ticket identification value, originating device identifier, and blockchain device identifier to a node included in a blockchain network associated with the blockchain, wherein the ownership transfer request is received and the electronic transmission is transmitted prior to reading of the displayed machine-readable code and receipt from the mobile computing device.

### Second Exemplary Method for Validating Ticket Authenticity

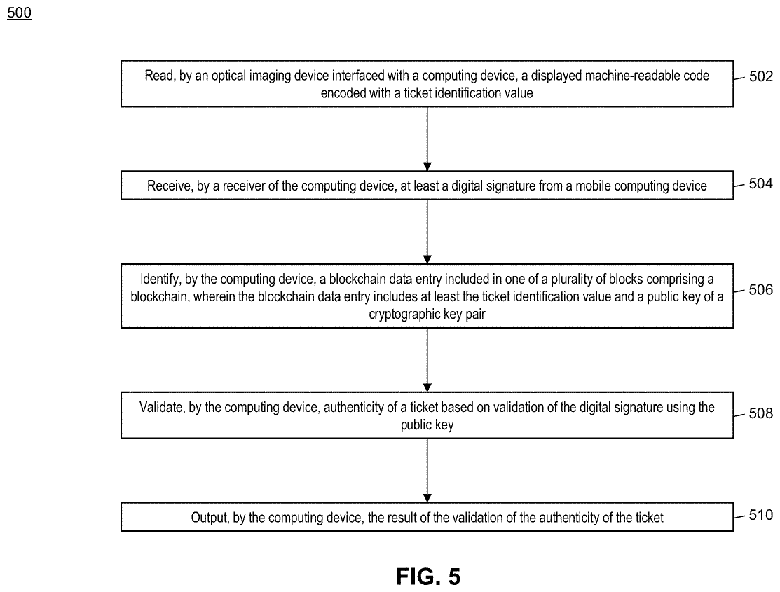

FIG. 5 illustrates a method 500 for the validation of ticket authenticity using a blockchain that utilizes a digital signature generated by a computing device to which the ticket is registered.

In step 502, a displayed machine-readable code encoded with a ticket identification value is read by an optical imaging device (e.g., the receiving device 202) interfaced with a computing device (e.g., the ticketing system 102). In step 504, at least a digital signature may be received by a receiver (e.g., the receiving device 202) of the computing device from a mobile computing device (e.g., the purchaser device 108).

In step 506, a blockchain data entry included in one of a plurality of blocks comprising a blockchain may be identified by the computing device, wherein the blockchain data entry includes at least the ticket identification value and a public key of a cryptographic key pair. In step 508, authenticity of a ticket may be validated by the computing device based on validation of the digital signature using the public key. In step 510, the result of the validation of the authenticity of the ticket may be output by the computing device.

In one embodiment, the method 500 may further include electronically transmitting, by a transmitter (e.g., the transmitting device 224) of the computing device, at least a receiver device identifier associated with the public key to an external system if validation of the authenticity of the ticket is unsuccessful. In some embodiments, outputting the result of the validation may include electronically transmitting, by a transmitter of the computing device, a signal to a locking mechanism interfaced with the computing device instructing the locking mechanism to unlock if the validation of the authenticity of the ticket is successful. In one embodiment, the digital signature may be generated by the mobile computing device using a private key of the cryptographic key pair.

### Computer System Architecture

FIG. 6 illustrates a computer system 600 in which embodiments of the present disclosure, or portions thereof, may be implemented as computer-readable code. For example, the processing server 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-5.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device specifically configured to perform the functions discussed herein. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3-5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

The processor device 604 may comprise one or more modules or engines configured to perform the functions of the computer system 600. Each of the modules or engines may be implemented using hardware and, in some instances, may also utilize software, such as corresponding to program code and/or programs stored in the main memory 608 or secondary memory 610. In such instances, program code may be compiled by the processor device 604 (e.g., by a compiling module or engine) prior to execution by the hardware of the computer system 600. For example, the program code may be source code written in a programming language that is translated into a lower level language, such as assembly language or machine code, for execution by the processor device 604 and/or any additional hardware components of the computer system 600. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 600 to perform the functions disclosed herein. It will be apparent to persons having skill in the relevant art that such processes result in the computer system 600 being a specially configured computer system 600 uniquely programmed to perform the functions discussed above.

Techniques consistent with the present disclosure provide, among other features, systems and methods for validating ticket authenticity. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for validating ticket authenticity, comprising:
reading, by an optical imaging device interfaced with a computing device, a displayed machine-readable code encoded with a ticket identification value;
receiving, by a receiver of the computing device, at least a receiver device identifier associated with a mobile computing device from the mobile computing device;
identifying, by the computing device, a blockchain data entry included in one of a plurality of blocks comprising a blockchain, wherein the blockchain data entry includes at least the ticket identification value and a blockchain device identifier;
validating, by the computing device, authenticity of a ticket based on a comparison of the receiver device identifier to the blockchain device identifier; and
outputting, by the computing device, the result of the validation of the authenticity of the ticket.

2. The method of claim 1, wherein outputting the result of the validation includes electronically transmitting, by a transmitter of the computing device, a signal to a locking mechanism interfaced with the computing device instructing the locking mechanism to unlock if the validation of the authenticity of the ticket is successful.

3. The method of claim 1, further comprising:
electronically transmitting, by a transmitter of the computing device, at least the receiver device identifier to an external system if validation of the authenticity of the ticket is unsuccessful.

4. The method of claim 1, further comprising:
receiving, by the receiver of the computing device, an ownership transfer request including at least the ticket identification value, an originating device identifier, and the blockchain device identifier; and
electronically transmitting, by a transmitter of the computing device, at least the ticket identification value, originating device identifier, and blockchain device identifier to a node included in a blockchain network associated with the blockchain, wherein
the ownership transfer request is received and the electronic transmission is transmitted prior to reading of the displayed machine-readable code and receipt from the mobile computing device.

5. A method for validating ticket authenticity, comprising:
reading, by an optical imaging device interfaced with a computing device, a displayed machine-readable code encoded with a ticket identification value;
receiving, by a receiver of the computing device, at least a digital signature from a mobile computing device;
identifying, by the computing device, a blockchain data entry included in one of a plurality of blocks comprising a blockchain, wherein the blockchain data entry includes at least the ticket identification value and a public key of a cryptographic key pair;
validating, by the computing device, authenticity of a ticket based on validation of the digital signature using the public key; and
outputting, by the computing device, the result of the validation of the authenticity of the ticket.

6. The method of claim 5, wherein outputting the result of the validation includes electronically transmitting, by a transmitter of the computing device, a signal to a locking mechanism interfaced with the computing device instructing the locking mechanism to unlock if the validation of the authenticity of the ticket is successful.

7. The method of claim 5, further comprising:
electronically transmitting, by a transmitter of the computing device, at least a receiver device identifier associated with the public key to an external system if validation of the authenticity of the ticket is unsuccessful.

8. The method of claim 5, wherein the digital signature is generated by the mobile computing device using a private key of the cryptographic key pair.

9. A system for validating ticket authenticity, comprising:
an optical imaging device interfaced with a computing device configured to read a displayed machine-readable code encoded with a ticket identification value;
a receiver of the computing device configured to receive at least a receiver device identifier associated with a mobile computing device from the mobile computing device; and
the computing device configured to
identify a blockchain data entry included in one of a plurality of blocks comprising a blockchain, wherein the blockchain data entry includes at least the ticket identification value and a blockchain device identifier,
validate authenticity of a ticket based on a comparison of the receiver device identifier to the blockchain device identifier,
output the result of the validation of the authenticity of the ticket.

10. The system of claim 9, wherein outputting the result of the validation includes electronically transmitting, by a transmitter of the computing device, a signal to a locking mechanism interfaced with the computing device instructing the locking mechanism to unlock if the validation of the authenticity of the ticket is successful.

11. The system of claim 9, further comprising:
a transmitter of the computing device configured to electronically transmit at least the receiver device identifier to an external system if validation of the authenticity of the ticket is unsuccessful.

12. The system of claim 9, further comprising:
a transmitter of the computing device, wherein
the receiver of the computing device is further configured to receive an ownership transfer request including at least the ticket identification value, an originating device identifier, and the blockchain device identifier,
the transmitter of the computing device is configured to electronically transmit at least the ticket identification value, originating device identifier, and blockchain device identifier to a node included in a blockchain network associated with the blockchain, and
the ownership transfer request is received and the electronic transmission is transmitted prior to reading of the displayed machine-readable code and receipt from the mobile computing device.

13. A system for validating ticket authenticity, comprising:
an optical imaging device interfaced with a computing device configured to read a displayed machine-readable code encoded with a ticket identification value;
a receiver of the computing device configured to receive at least a digital signature from a mobile computing device; and
a computing device configured to
identify a blockchain data entry included in one of a plurality of blocks comprising a blockchain, wherein the blockchain data entry includes at least the ticket identification value and a public key of a cryptographic key pair,
validate authenticity of a ticket based on validation of the digital signature using the public key, and
output the result of the validation of the authenticity of the ticket.

14. The system of claim 13, wherein outputting the result of the validation includes electronically transmitting, by a transmitter of the computing device, a signal to a locking mechanism interfaced with the computing device instructing the locking mechanism to unlock if the validation of the authenticity of the ticket is successful.

15. The system of claim 13, further comprising:
a transmitter of the computing device configured to electronically transmit at least the receiver device identifier to an external system if validation of the authenticity of the ticket is unsuccessful.

16. The system of claim 13, wherein the digital signature is generated by the mobile computing device using a private key of the cryptographic key pair.
